(19) United States
(12) Patent Application Publication
(10) Pub. No.: US 2006/0080246 A1
(43) Pub. Date: Apr. 13, 2006

(54) Energy efficient homeownership mortgage program

(75) Inventor: Ronald P. Wyckoff, Carlisle, IA (US)

Correspondence Address: Brian J. Laurenzo;Dorsey & Whitney LLP, Suite 3900, 801 Grand Avenue, Des Moines, IA, 50309, US

(73) Assignee: Don Wyckoff Heating, Inc., Des Moines, IA (US)

(21) Appl. No.: 11/248,913

(22) Filed: Oct. 11, 2005

Related U.S. Application Data
(60) Provisional application No. 60/616,976, filed on Oct. 8, 2004.

(51) Int. Cl. G06Q 40/00

(52) U.S. Cl. 705/40

(57) ABSTRACT

A program for encouraging homebuyers to purchase more efficient HVAC equipment at the time they purchase an existing house is described. The purchase price of the HVAC equipment is included in the mortgage loan. The overall monthly cost of the mortgage payment and heating and cooling costs is lowered for any given house. The program is marketed through a real estate agent working closely with a HVAC supplier. A central control entity may oversee the process, provide standardized forms, and locate appropriate installers.

This application claims priority from U.S. Provisional Application No. 60/616,976, filed Oct. 8, 2004, which is hereby incorporated in its entirety.

### BACKGROUND

This invention relates generally to a program to encourage homebuyers to install energy efficient heating, ventilation, and air conditioning (“HVAC”) equipment at the time they purchase their homes. More specifically, the invention relates to a program wherein energy efficient HVAC equipment is marketed to a homebuyer to encourage the homebuyer to replace existing HVAC equipment with new, more energy efficient equipment, and thereby reduce the total monthly payments associated with that house.

It is well known that replacing existing furnaces and air conditioning units with newer, more efficient units, can result in significant financial savings for the home owner due to lowered energy costs. However, many home owners cannot afford to pay the up-front cost associated with installing the new units. They may be reluctant to finance such a purchase, either because of prohibitively high interest rates associated with doing so with a consumer credit card, or because of relatively high origination fees associated with a consumer-type loan for purchasing such units. The amortization time on a loan associated with a furnace may be short enough that, at least in the short term, the monthly payment associated with the loan for the furnace is greater than the monthly savings in energy costs. Furthermore, many consumers are simply not aware of the potential savings available by switching to a higher efficiency unit.

### SUMMARY OF THE INVENTION

The program of the present invention solves many of these problems. According to the program, a real estate agent informs a homebuyer of the option of replacing the existing furnace and/or air conditioning unit in the house being purchased with new, more energy efficient units. The cost of the new units may be included in the mortgage for the purchase price of the home.

An equipment supplier works with the real estate agent to provide specific cost figures associated with the purchase price of the new heating and air conditioning equipment, as well as expected monthly savings to be realized by switching to the new equipment. In many instances, the total monthly payment associated with the mortgage and energy costs will be lower when the homebuyer replaces existing HVAC equipment with new, more energy efficient equipment. The program is therefore beneficial to homebuyers, who can lower their monthly payments associated with any given house. It is beneficial to the real estate agent because home owners can afford to buy houses having higher purchase prices, which result in higher commissions. It is beneficial for the furnace and air conditioner supplier because additional sales will be made. Furthermore, it is beneficial to the environment because it encourages the switch to more energy efficient HVAC equipment.

### BRIEF DESCRIPTION OF THE DRAWINGS

FIG. 1 is a diagram illustrating the flow of information, money, and equipment according to one embodiment of the present invention;

FIG. 2 is a diagram illustrating the flow of information, money, and equipment according to another embodiment of the present invention utilizing a facilitator; and

FIG. 3 is an example of a bid sheet that may be used in conjunction with one embodiment of the present invention.

### DETAILED DESCRIPTION OF PREFERRED EMBODIMENTS

The present invention relates to a method and system for encouraging homebuyers to replace existing HVAC equipment with new more efficient HVAC equipment when they purchase an existing home. By coordinating the efforts of a real estate agent with HVAC suppliers and installers, homebuyers can be shown how to lower their expected cost of owning a home by replacing HVAC equipment when they buy an existing house. In certain embodiments, it may be desirable to utilize a facilitator who helps to coordinate the efforts of the real estate agent and the HVAC installer, as well as facilitate the flow of information between the parties. It should be understood that while the primary intent of the application is for use in association with heating ventilation and air conditioning equipment, other energy efficient improving products may also be included to equal advantage, such as new windows, improved insulation, new water heaters, and the like.

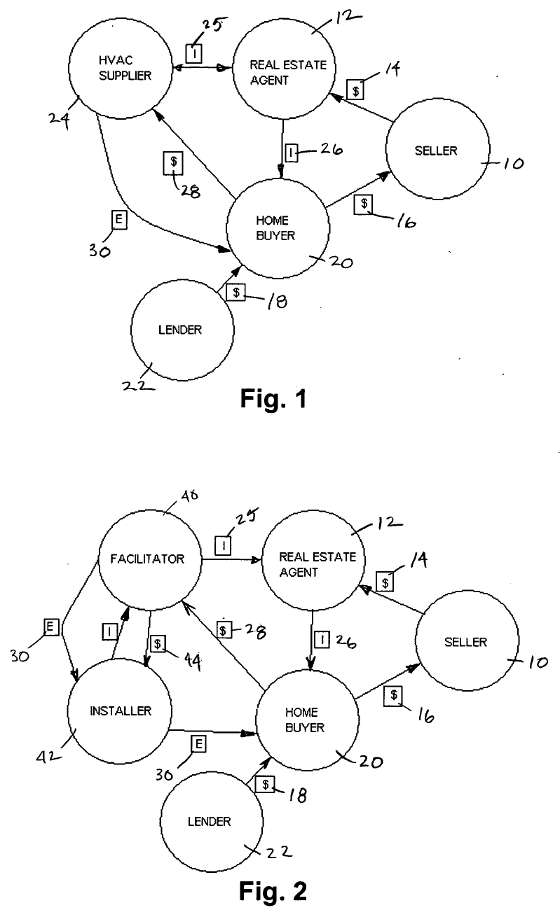

FIG. 1 shows the flow of information, money, and equipment according to one embodiment of the present invention. The invention envisions that a seller 10 is selling a home which includes existing HVAC equipment, including, for example, a furnace and air conditioning unit. The present invention is most advantageous when the existing HVAC equipment is old and inefficient. It should be noted, however, that recent advances in technology have resulted in significant recent gains in efficiency. Therefore, it is common for even relatively new existing HVAC equipment to be relatively inefficient compared to available replacement equipment.

Commonly, the seller 10 will have retained a real estate agent 12 to help in marketing and selling the house. The seller 10 will pay to the real estate agent 12 a commission 14 from the proceeds of the sale of the house. A homebuyer 20 is purchasing the home from the seller 10 for an agreed upon price 16. The homebuyer 20 may use the same or a different real estate agent (not shown) to help in finding the home, negotiating the selling price, and advising the homebuyer regarding the home buying process. For the purpose of the present invention, either arrangement will work. If the homebuyer 20 does have a separate real estate agent, the seller's real estate agent 12 will typically split the commission 14 paid by the seller 10 with the buyer's real estate agent.

In order to have the money to pay the purchase price 16 for the home to the seller 10, the homebuyer 20 will typically need to obtain a loan in the form of a home mortgage 18 from a lender 22. The lender 22 will typically be a bank, savings and loan, credit union, or similar lending institution. The homebuyer 20 will take the money from the loan 18, and pay it to the seller 20 as part of the purchase price 16 for the home. The homebuyer 20 will then make installment payments, typically on a monthly basis, to the lender paying back interest as well as principle on the loan. Commonly, the amortization period for such a mortgage loan will be somewhere between 15 and 30 years. Some, or all, of the interest paid by the homebuyer to the lender may be tax deductible.

Thus far, a conventional sale and purchase of a home has been described. The present invention, as best seen in FIG. 1, adds new features to this standard transaction. The real estate agent 12 provides information 25 to the HVAC supplier regarding the existing HVAC equipment as well as other properties of the house, such as the size and type of house. Using the information 25 received from the real estate agent 12, the HVAC supplier 24 determines an expected monthly cost for operating the existing HVAC equipment, an expected cost for providing new energy efficient HVAC equipment, and an expected operating cost the new HVAC equipment 30. The real estate agent 12 provides this information 26 to the homebuyer 20.

If the homebuyer 20 decides to purchase new HVAC equipment 30, the real estate agent 12 provides the homebuyer 20 with the necessary paperwork to order the appropriate equipment from the HVAC supplier 24. This paperwork creates an agreement between the homebuyer 20 and the HVAC supplier 24. According to the agreement, the homebuyer 20 agrees to finance the indicated HVAC equipment as part of the homebuyer's mortgage loan 18. When the sale of the home closes, a portion 28 of the proceeds from the mortgage loan 18 are paid to the HVAC supplier 24, rather than to the home seller 10. It should be appreciated that the money may be paid directly by the lender to the HVAC supplier 24, or may be paid to the homebuyer 20 who then pays the HVAC supplier 24 as shown in FIG. 1. Alternatively, the proceeds 28 to pay for the HVAC equipment and installation of the HVAC equipment may be paid to an escrow account at closing, and then distributed to the HVAC supplier 24 upon satisfactory installation of the HVAC equipment 30 into the purchased home.

Home ownership may be thought of as having five areas of expense: principal, interest, taxes, utilities, and maintenance and insurance. The overall cost of homeownership may therefore be determined by adding, or summing, all of these factors. Ideally the overall cost of homeownership is determined on a monthly basis because most mortgages and utilities require payment on a monthly basis. Other time periods could also be effectively used without departing from the invention. The benefits of the present invention are realized because the homebuyer 20 is reducing the overall costs of home ownership. Specifically, the additional amount of principal and interest due each month because of the new HVAC equipment is more than offset by the expected savings in utilities and maintenance costs. By lowering the overall cost of home ownership, and by including the purchase price 28 of the new HVAC equipment 30 into the mortgage loan 18, the monthly cash flow for the homebuyer 20 is improved.

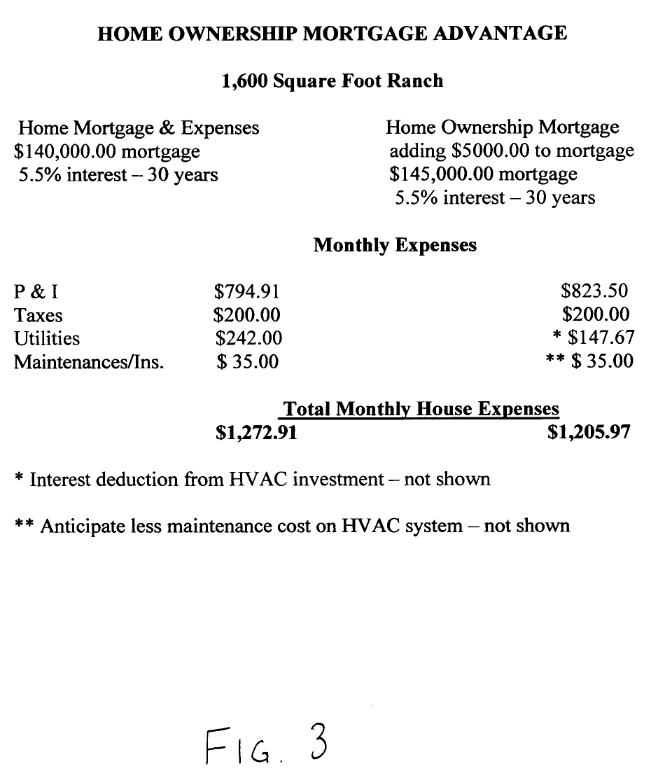

Unfortunately, many homebuyers do not realize this potential cash flow savings. Therefore, there is a need for the present invention that utilizes communication between the real estate agent 12, the HVAC supplier 24, and homebuyers 20. The real estate agent 12 provides the necessary information to the HVAC supplier 24, such as home style, square footage, and location, to permit the HVAC supplier 24 to present a bid. An example of a form for a written bid is shown in FIG. 3. The details and style of a bid may naturally vary from that shown in FIG. 3. The bid will may include a breakdown of the cost of the equipment, cost of installation, as well as a breakdown of estimated monthly savings in energy costs. Importantly, the bid information from the HVAC supplier 24 would also include a comparison of the total monthly cost of ownership for the home as it currently exists and the expected monthly cost of ownership if new HVAC equipment 30 is installed.

FIG. 2 illustrates another embodiment of the present invention wherein the process is improved through the use of a facilitator 40. The facilitator 40 performs as a coordinator for all the participants in the process. The facilitator 40 may act to find HVAC suppliers to provide equipment to installers 42 who actually perform the installation. In the embodiment shown in FIG. 2, it is presumed that the facilitator 40 purchases the new HVAC equipment from a preferred supplier (not shown), and provides the equipment to the installer 42. Most preferably, the facilitator 40 will provide standardized forms and literature for the real estate agent 12 and the installer 42, and coordinates finding suitable real estate agents 12, HVAC equipment suppliers, and installers 42 in desired geographic locations. The standard forms may include bid documents, purchase agreements, advertising materials, and the like.

According to the embodiment of FIG. 2, a real estate agent 12, working with the facilitator 40 provides the homebuyer 20 information related to total expected home ownership costs for the home being purchased. For example, a bid sheet shown in FIG. 3 might be provided by the real estate agent 12 to the homebuyer 20. The bid sheet would need to be prepared in consultation with the installer 42, who might inspect the home in preparation for preparing the bid sheet. If the homebuyer desires to have the new HVAC equipment 30 installed, the homebuyer 20 may be presented with a standardized contract setting forth the terms of a purchase and installation contract. It may provide that the cost 28 of the equipment and installation will be paid from proceeds of the mortgage loan 18, either as a direct payment to the facilitator 40 by the homebuyer 20, or to be held in escrow and then paid to the facilitator 40 upon satisfactory installation of the new HVAC equipment 30. The facilitator 40 would then pay the installer 42 an installation fee 44.

According to the embodiment of FIG. 2, therefore the facilitator 40 serves several functions. The facilitator 40 would enroll and train real estate agents 12 and installers 42. The facilitator may find appropriate manufacturers for HVAC equipment to participate in the program. Upon receiving notification from a real estate agent of a willing homebuyer wanting to receive a bid, the facilitator would contact a participating installer 42, and approve the bid prepared by the installer 42. The facilitator 40 would place the order for the new HVAC equipment 30 and have it delivered to the installer 42 for installation in the house. The installer 42 will preferably provide the facilitator 42 with a notification when the new HVAC equipment has been installed so that the facilitator can invoice the homebuyer, or have the escrow funds released. Upon being paid by the homebuyer or escrow agent, the facilitator 40 will pay the installer 42 and the HVAC supplier.

The installer 42 also has several duties. The installer 42 will evaluate the home for current efficiency and recommend new HVAC equipment. The installer 42 should communicate the materials needed for the new HVAC equipment to the facilitator 40, so that the facilitator can review and authorize the proposed new HVAC equipment. The installer 42 will receive the new HVAC equipment and make arrangements for its installation. The installer 42 will inform the facilitator 40 when the job has been completed, and will submit any necessary rebate and warranty papers. The installer 42 may also perform normal warranty service as needed.

The present invention provides benefits for all involved, and should facilitate increased installation of high efficiency HVAC equipment. The homebuyer 20 benefits by having a lower monthly cost of home ownership. In addition to the factors already discussed, the homebuyer may expect to reap additional savings in the form of an income tax write-off based on the interest paid for financing the HVAC equipment. Rebates may be available from energy companies in response to installing high-efficiency equipment. Maintenance costs can be expected to be reduced. Additionally, the new equipment often provides superior performance in terms of evenness of heat and comfort. Pease of mind is also increased by the reliability of new HVAC equipment as opposed to used. Finally, the homebuyer 20 may feel good about conserving energy.

Mortgage lenders 22 benefit by being able to lend higher principal mortgages that include the cost new HVAC equipment. There is less chance of default because the homebuyers have a decreased total cost of ownership. More buyers may qualify for loans as a result of the lowered total cost for home ownership. It therefore provides a marketing tool for mortgage lenders.

Real estate agents benefit by being able so sell more and higher priced houses by virtue of the lowered total ownership cost. Additionally, they are likely to receive fewer sales conflicts that can result from faulty existing HVAC equipment. Listing sellers may be likely to seek out real estate agents who provide this service, resulting in increased listings and listing commissions.

Finally, society as a whole benefits from the increased use of high efficiency HVAC equipment and corresponding lowered use of energy.

Although various representative embodiments of this invention have been described above with a certain degree of particularity, those skilled in the art could make numerous alterations to the disclosed embodiments without departing from the spirit or scope of the inventive subject matter set forth in the specification and claims.

1. A method of encouraging a homebuyer to install energy efficient HVAC equipment in a home having an existing HVAC system, the method comprising the steps of:
determining an expected ongoing existing utilities cost if the existing HVAC system is left in place;
determining an expected ongoing new utilities cost if the existing HVAC system is replaced with a new HVAC system;
determining an expected replacement cost for the new HVAC system;
determining an expected mortgage payment for the home with the existing HVAC system;
determining an expected mortgage payment for the home including the replacement cost for the new HVAC system;
determining an expected cost of ownership for the home with the existing HVAC system equal to the expected mortgage payment for the home with the existing HVAC system plus the expected ongoing existing utilities cost;
determining an expected cost of ownership for the home with new HVAC system equal to the expected mortgage payment for the home with the new HVAC system plus the expected ongoing new utilities cost; and
communicating with the homebuyer a comparison of the expected cost of ownership for the home with the existing HVAC system with the expected cost of ownership for the home with a new HVAC system.
